(19) United States
(12) Patent Application Publication
(10) Pub. No.: US 2014/0158325 A1
(43) Pub. Date: Jun. 12, 2014

(54) THIN BARRIER BI-METAL HEAT PIPE

(71) Applicant: Paul Gwin, Orangevale, CA (US)

(72) Inventor: Paul Gwin, Orangevale, CA (US)

(21) Appl. No.: 13/710,553

(22) Filed: Dec. 11, 2012

(51) Int. Cl. F28D 15/04; B23P 15/26

(52) U.S. Cl. CPC F28D 15/04; B23P 15/26
USPC 165/104.26; 29/890.032

(57) ABSTRACT

An apparatus is disclosed herein. The apparatus includes a heat pipe configured to cool a heat-generating device, and a heat exchanger. The heat pipe includes an outer structure containing aluminum, coolant disposed within the outer structure, and a barrier layer disposed between the coolant and the outer structure.

### TECHNICAL FIELD

The claimed subject matter relates generally to cooling computer systems. More specifically, the claimed subject matter relates to a thin barrier bi-metal heat pipe.

### BACKGROUND ART

Portable electronic devices such as laptops, tablets, smart phones, and the like, are growing in popularity due to a wide array of functionality, high performance, and convenience. Unfortunately, these conveniences are resource-intensive, which increases the load on the hardware. Accordingly, as more functions are integrated into these devices, the heat generated by these devices increases. The increase in heat becomes a drain on other resources, e.g., battery power. One additional drain on battery power comes from thermal management, i.e., hardware and software that regulate device temperatures.

One technique for thermal management includes using heat pipes. A heat pipe is a passive heat transfer device. The heat pipe has no moving parts, but effectively transfers heat away from heat sources in electronic devices. A working fluid inside the heat pipe cycles through vapor and liquid states, thereby removing heat from the heat source. There are on-going efforts to improve the efficiency of heat pipe cooling systems.

### BRIEF DESCRIPTION OF THE DRAWINGS

FIG. 1 is a block diagram of an example computer system, in accordance with embodiments;

FIG. 2A is a block diagram of an exemplary cooling system using heat pipes, in accordance with embodiments;

FIGS. 2B and 2C are top and cross-section views, respectively, of an attach block with two heat pipes, in accordance with embodiments;

FIGS. 3A and 3B are cross-section views of example cylindrical and flat heat pipes, in accordance with embodiments; and

FIG. 4 is a process flow diagram showing a method for generating a heat pipe, in accordance with embodiments.

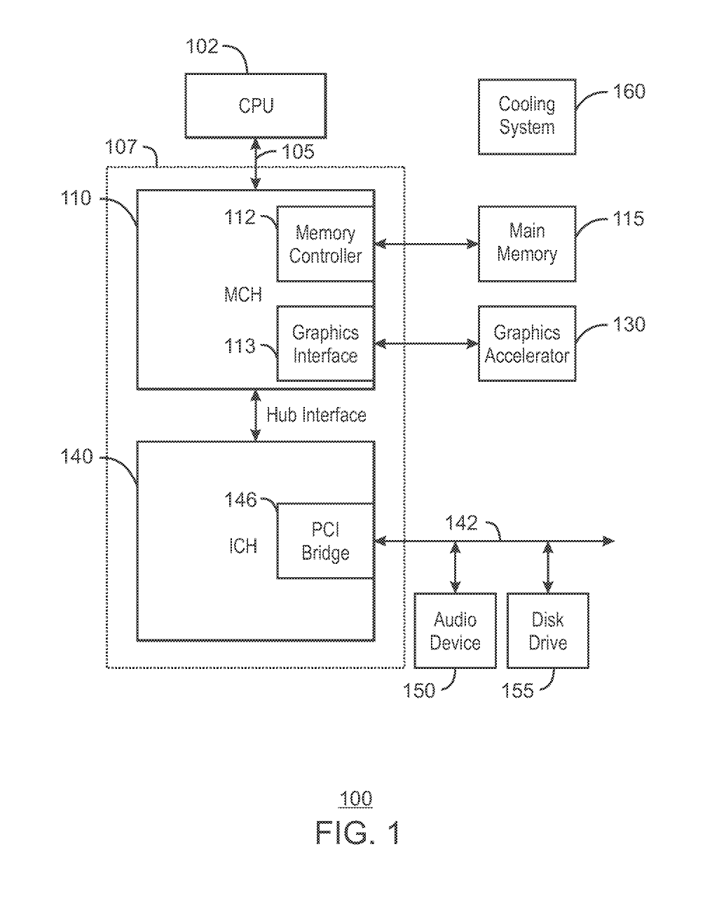

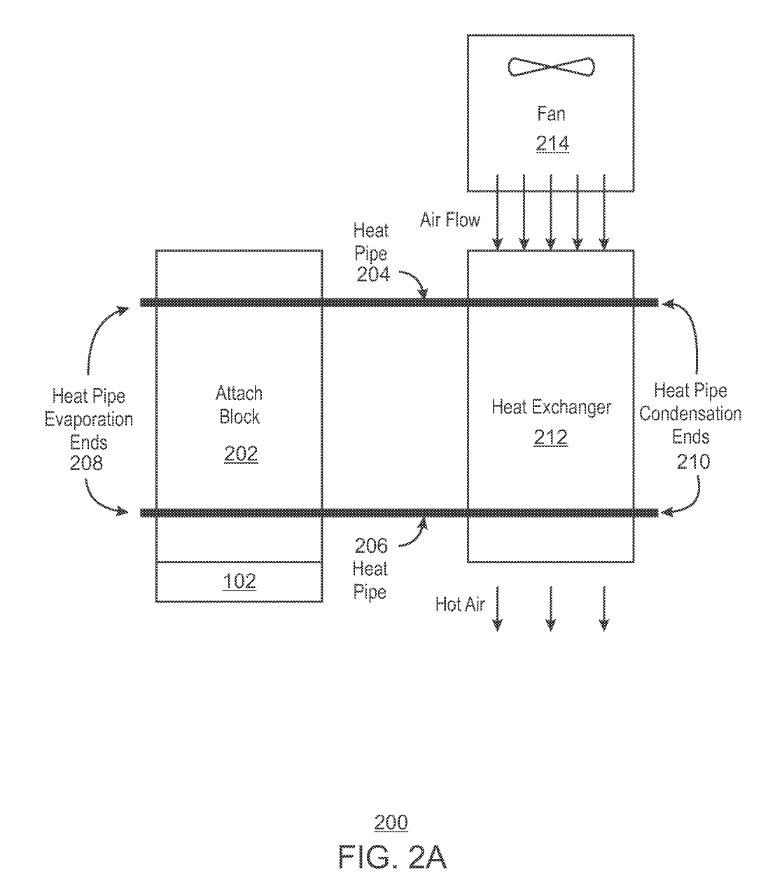

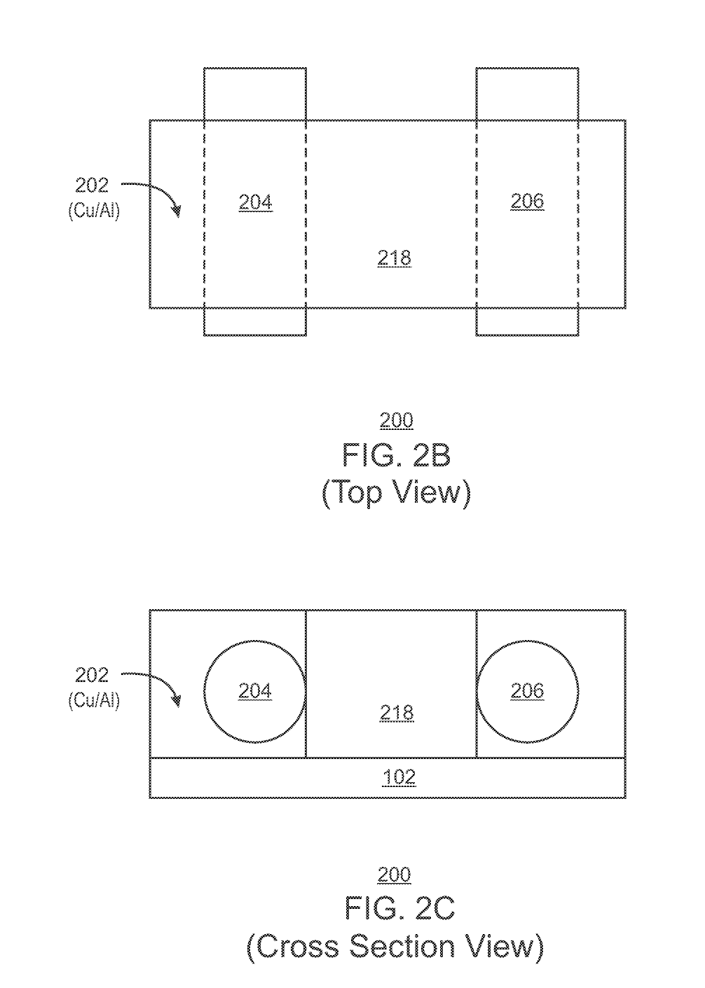

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

In the following detailed description, numerous specific details are set forth in order to provide a thorough understanding. However, it will be apparent to one skilled in the art that embodiments may be practiced without these specific details. In other instances, well-known structures and devices are shown in block diagram form, rather than in detail, in order to avoid obscuring embodiments.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Typically, heat pipes are made from various metals based on their thermal conductivity. Thermal conductivity is an indicator of an object's ability to conduct heat. The efficiency of the heat pipe improves as thermal conductivity of the heat pipe material increases. Example metals include, but are not limited to copper and aluminum. Heat pipes made from copper or copper alloys may be used with a water phase change fluid, which may be less expensive and more efficient than other typical coolants. Aluminum heat pipes may also provide a cost advantage over copper heat pipes. However, water cannot be used as a coolant in aluminum heat pipes because hydrogen gas results from the interaction of water with the aluminum. Hydrogen gas is non-condensable gas, and as such, increases the pressure inside, thereby decreasing or blocking condensation of the H2O gas, which may render the heat pipe useless.

In one embodiment, an aluminum heat pipe uses a thin barrier metal and a water coolant. The thin barrier metal prevents the water coolant from interacting with the aluminum. Advantageously, such an embodiment has lower mass and cost than typical copper heat pipes in computing devices.

FIG. 1 is a block diagram of an example computer system 100, in accordance with embodiments. The computer system may include, but not be limited to, a lightweight computer system, such as a notebook, tablet, smartphone, and the like. Although not shown, the computer system 100 may receive electrical power from a direct current (DC) source (e.g., a battery) or from an alternating current (AC) source (e.g., by connecting to an electrical outlet). The computer system 100 includes a central processing unit (CPU) or processor 102 coupled to a bus 105.

The computer system 100 may also include chipset 107 coupled to the bus 105. The chipset 107 may include a memory control hub (MCH) 110. The MCH 110 may include a memory controller 112 that is connected to a main memory 115. The main memory 115 may store data and sequences of instructions that are executed by the processor 102, or any other device included in the system 100. In one embodiment, the main memory 115 includes computer-readable media such as, volatile memory and nonvolatile memory. The nonvolatile memory may include read-only memory (ROM), programmable ROM (PROM), electrically-programmable ROM (EPROM), electrically-erasable programmable ROM (EEPROM), flash memory, and so on.

Volatile memory may include random access memory (RAM), such as static RAM (SRAM), dynamic RAM (DRAM), synchronous DRAM (SDRAM), double data rate SDRAM (DDR SDRAM), enhanced SDRAM (ESDRAM), DRAM (SLDRAM), direct RAM (RDRAM), direct dynamic RAM (DRDRAM), dynamic RAM (RDRAM).

The MCH 110 may also include a graphics interface 113 that is connected to a graphics accelerator 130. The graphics interface 113 may be connected to the graphics accelerator 130 via an accelerated graphics port (AGP). Additionally, a display (not shown) may be connected to the graphics interface 113. The MCH 110 may be connected to an input/output control hub (ICH) 140 via a hub interface. The ICH 140 provides an interface to input/output (I/O) devices within the computer system 100. The ICH 140 may be connected to a Peripheral Component Interconnect (PCI) bus. Thus, the ICH 140 may include a PCI bridge 146 that provides an interface to a PCI bus 142. The PCI bridge 146 may provide a data path between the CPU 102 and peripheral devices such as, for example, an audio device 150 and a disk drive 155. Although not shown, other devices may also be connected to the PCI bus 142 and the ICH 140.

The processor 102 and graphics accelerator 130 are examples of heat-generating devices. For proper functioning of the CPU 102 and other components in the computer system 100, the temperature of heat-generating devices is regulated by a cooling system 160.

FIG. 2A is a block diagram of an example heat pipe cooling system 200, in accordance with one embodiment. The cooling system 200 includes attach block 202, and heat pipes 204, 206. The heat pipes 204, 206 each include evaporation ends 208 and condensation ends 210, which are explained in greater detail below. The cooling system 200 also includes a heat exchanger 212, and a fan 214.

The attach block 202 is coupled to a heat-generating device, e.g., processor 102 to extract heat from the device. The attach block 202 may be manufactured using copper, aluminum, or other metals based on their thermal conductivity. The attach block 202 may be coupled to the processor 102 through a thermal interface material.

The attach block 202 is coupled, or otherwise connected, with the heat pipes 204, 206. The heat pipes 204, 206 are sealed tubes made of an aluminum or aluminum alloy. The heat pipes 204, 206 may include water or water containing mixture as a coolant. The inside of the heat pipes 204, 206 are typically at a low pressure, in some cases, nearing a vacuum. The amount of water and pressure inside the heat pipes 204, 206 may be based on the operating temperature of the processor 102.

In the cooling system 200, heat from the processor 102, enters the heat pipes 204, 206 at an evaporation portion of the heat pipes 204, 206, such as the evaporation ends 208, causing the coolant inside to vaporize. The vapor flows along the heat pipes 204, 206 towards the condensation ends 210 due to a pressure gradient caused by the vaporization. At a condensation portion of the heat pipes 204, 206, such as the condensation end 210, the coolant condenses, giving up latent heat of the vaporization.

The heat exchanger 212 removes heat from the heat pipes, helping to cool the condensation ends 210. The heat exchanger 212 may include a fan 214 to provider higher airflow. It is noted that, in some embodiments, the heat exchanger 212 may not include the fan 214.

The heat exchanger 212 may be manufactured using aluminum, or aluminum alloys. Additionally, the heat exchanger 212 may be bonded with the heat pipes 204, 206. The bonding materials for such a connection may be an aluminum alloy with a lower melt temperature than the inner aluminum alloy of the heat pipe and the inner aluminum alloy of the heat exchanger fins. These elements of the system 200 may be bonded by placing them in an oven at a temperature above the melt temperature of the cladding material, but below that of the metals of the heat exchanger 212 and heat pipes 204, 206.

In one embodiment, the outer material of the heat pipes 204, 206 may be skived into fins that provide the heat exchanger function. Skiving is process whereby a thin layer of metal is peeled upward, resembling a fin of the heat exchanger 212. In such an embodiment, the system 200 may not include the heat exchanger 212 in addition to the skived heat pipes.

FIGS. 2B and 2C illustrate a top view and a cross-section view, respectively, of the attach block 202 with the two heat pipes 204, 206, in accordance with one embodiment. The two heat pipes 204, 206 and the attach block 202 are near-centrally disposed with respect to the processor 102. Additionally, the two heat pipes 204, 206 are separated by a bridge area 218. The bridge area 218 separates the heat pipes 204, 206 by a specified distance, typically ranging from 1 to 3 millimeters (mm). As understood by one of ordinary skill in the art, the specified distance of the bridge area 218 may vary based on the specific embodiment. It is noted that heat pipes may have different shapes, and are not limited to the round heat pipes 204, 206. The use of different shapes for heat pipes is useful for accommodating heat pipes within the typically cramped confines of the computing device 100.

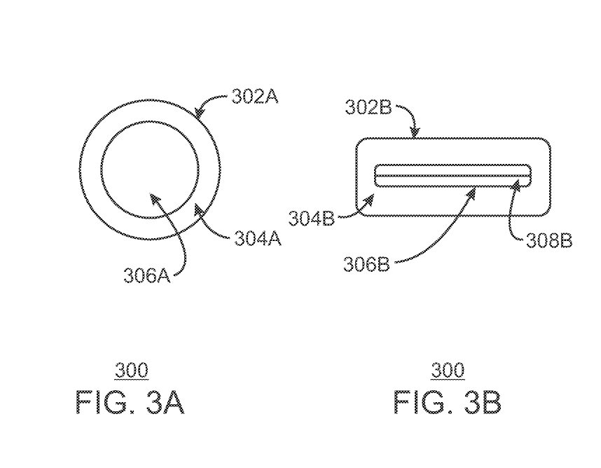

FIGS. 3A and 3B are block diagrams of example heat pipes 300A, 300B, in accordance with an embodiment. Heat pipe 300A is a round heat pipe. Heat pipe 300B is a flat-thin heat pipe, also referred to herein as a fin. Each of the heat pipes 300A, 300B, include structural outers 302A, 302B, copper barriers 304A, 304B, and fluid vapor mix channels 306A, 306B. The structural outers 302A, 302B are made from intermetallic compounds that include aluminum. The copper barriers 304A, 304B are a thin film inside the structural outer 302A, 302B that provides a barrier between a water coolant and the structural outers 302A, 302B. The copper barriers 304A, 304B include copper.

Depending on the service temperature, the thickness of the structural outers 302A, 302B, may develop and grow in thickness. As such, aluminum atoms may protrude through the copper barriers 304A, 304B, and come into contact with water. However, in one embodiment, the heat pipes 300A, 300B include a thin intermetallic compound barrier layer (not shown) that may be disposed between the structural outers 302A, 302B, and the copper barriers 304A, 304B. Alternatively the intermetallic compound barrier layer may be disposed between the copper barriers 304A, 304B, and the water.

The thin IMC barrier layer, for example, may be composed of a copper alloy containing a percentage of nickel that inhibits the growth or diffusion of aluminum atoms to the IMC. The thin IMC barrier layer is not limited to a copper alloy containing nickel. This layer may be composed of materials based on a predetermined level of IMC growth inhibition.

The heat pipe 300B includes a wicking mechanism, such as a screen mesh 308B and a sintered copper powder wick that may be made from a metal, such as copper. Other materials that may be used as the wick include fabrics, non-woven plastic fabrics, fiberglass, and the like. The wicking mechanism 308B exerts a capillary pressure on the liquid water, moving the water from the condensation ends 210 back to the evaporation ends 208. In the round heat pipe 300A, a wicking mechanism may be provided by micro-grooving a series of lines in the copper barrier 304A parallel with respect to the pipe axis. Such grooves exert capillary pressure on liquid coolant toward the evaporation ends 208. The heat pipes 300A, 300B may not use a wicking mechanism if another source of acceleration is provided to overcome the surface tension of the liquid coolant. For example, the condensation ends 210 may be tilted upwards, enabling the acceleration from gravity to move the liquid coolant back to the evaporation ends 208.

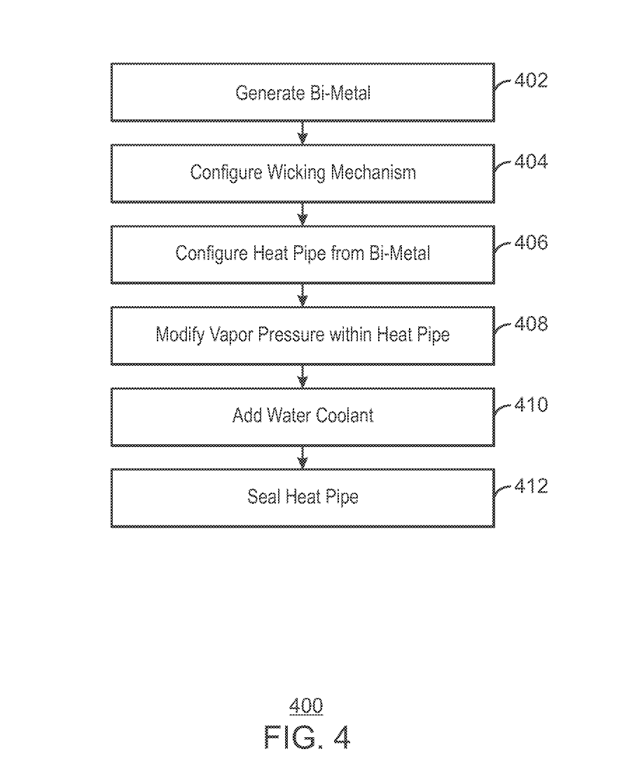

FIG. 4 is a process flow diagram for a method 400 to manufacture a thin barrier bi-metal heat pipe, in accordance with an embodiment. The method begins at block 402, where a bi-metal is generated for a heat pipe, such as heat pipe 204. The bi-metal includes aluminum for an outer structure of the heat pipe 204, and a copper lining on one side of the aluminum. The copper lining provides the barrier between the water coolant and the aluminum outer structure. There are multiple methods of fabricating the bi-metallic tubing. In one embodiment, the thin barrier copper film 304A, 304B may be generated by applying copper to the aluminum for the structural outer using techniques, such as diffusion bonding, electro-deposition, chemical vapor deposition and, physical vapor deposition, among others.

In diffusion bonding, the aluminum and the copper are bonded together by migrating atoms of copper across a joint with the aluminum, due to concentration gradients. The two metals are pressed together at an elevated temperature, less than the melting point of either. The pressure relieves the void that may occur due to the different topographies of the metal surfaces.

In electro-deposition, copper ions in a solution are moved by an electric field to coat the aluminum. An electrical current reduces cations of the copper from the solution and coat the aluminum with a thin layer, e.g., several atoms, of the copper.

In chemical vapor deposition, a vacuum deposition method may be used to deposit a thin film of copper on the aluminum. The film is deposited by the reaction of a vaporized copper compound, such as Cu(II) bis-hexafluoroactylactonate, among others, with the aluminum surfaces. A copper layer is deposited, and the resulting organic compounds are swept out with a feed gas.

Physical vapor deposition may also be used. Physical vapor deposition involves the high temperature vacuum evaporation of copper from a surface, for example, by electron or plasma bombardment, with subsequent condensation on the target aluminum surface.

In-air plasma deposition may also be used, where a plasma deposits Cu atoms on the surface of the aluminum in an air environment. The plasma reduces surface contaminants and oxidation, thereby preparing the surface of the aluminum for covalent bonding of the Cu, and deposits the Cu on the surface of the aluminum to produce the barrier layer.

At block 404, a wicking mechanism is configured for the heat pipe. For a round heat pipe, a micro grooving operation is applied to the aluminum to provide the wicking mechanism. The microgrooving is done before the copper deposition on to the aluminum. In this way, the microgrooving prevents loss of the thin copper layer from the surface. For a flat-thin heat pipe, a copper screen mesh may be positioned in relation to the bi-metal such that when formed, the heat pipe 204 encloses the screen mesh. In other embodiments, a fabric mesh may be placed inside the bimetal pipe.

At block 406, a heat pipe is configured from the bi-metal such that the copper lining is disposed within the heat pipe 204. The configured heat pipe 204 may be a round heat pipe, or a flat-thin heat pipe.

At block 408, the vapor pressure within the heat pipe 204 may be modified. In one embodiment, air from within the heat pipe 204 is evacuated until the pressure inside reaches a specified threshold.

At block 410, a water coolant is added to the inside of the heat pipe. At block 412, the heat pipe is sealed.

Advantageously, the heat pipe 204 has lower mass, and, accordingly, a lower cost than heat pipes made from heavier, more expensive metals, such as copper. Such a heat pipe enables thermal solution providers to create cooling systems at a cost savings over typical solutions.

It is to be understood that specifics in the aforementioned examples may be used anywhere in one or more embodiments. For instance, features of the computing device described above may alternatively be implemented with respect to either of the methods or the computer-readable medium described herein. Furthermore, although the Figures herein describe embodiments, embodiments of the claimed subject matter are not limited to those diagrams or corresponding descriptions. For example, flow need not move through each illustrated box of FIG. 4 in the same specific order as illustrated herein.

Embodiments are not restricted to the particular details listed herein. Indeed, those skilled in the art having the benefit of this disclosure will appreciate that many other variations from the foregoing description and drawings may be made. Accordingly, it is the following claims, including any amendments thereto, that define the scope.

What is claimed is:

1. An apparatus, comprising:
a heat pipe configured to cool a heat-generating device, comprising an outer structure comprising aluminum;
coolant disposed within the barrier layer; and
a barrier layer comprising copper, wherein the barrier layer is disposed between the coolant and the outer structure.

2. The apparatus of claim 1, wherein the coolant comprises water, and wherein the barrier layer prevents interaction between the water and the aluminum.

3. The apparatus of claim 1, comprising a heat exchanger.

4. The apparatus of claim 3, wherein:
the heat exchanger comprises a first aluminum alloy;
the outer structure comprises a second aluminum alloy;
the heat exchanger is bonded to the heat pipe with a cladding material associated with a melt temperature lower than:
a melt temperature of the first aluminum alloy; and
a melt temperature of the second aluminum alloy.

5. The apparatus of claim 1, wherein the heat pipe comprises a flat-thin heat pipe.

6. The apparatus of claim 5, wherein the heat pipe comprises a wicking comprising copper configured to apply capillary pressure to the coolant, moving the coolant from a condensation portion of the heat pipe to an evaporation portion of the heat pipe.

7. The apparatus of claim 1, comprising an additional barrier layer comprising an intermetallic compound, wherein the additional barrier layer is disposed between the barrier layer and the coolant.

8. The apparatus of claim 1, wherein:
the heat pipe comprises a heat exchanger; and
the heat exchanger comprises a plurality of fins from an outer structure of the heat pipe.

9. A system, comprising:
a device capable of generating heat;
a heat pipe configured to cool the device, comprising:
an outer structure comprising aluminum;
coolant disposed within the outer structure; and
a barrier layer comprising copper, that is disposed between the coolant and the outer structure.

10. The system of claim 8, wherein the coolant comprises water, and wherein the barrier layer prevents interaction between the water and the aluminum.

11. The system of claim 9, comprising a heat exchanger.

12. The system of claim 11, wherein the heat exchanger comprises a plurality of fins from an outer structure of the heat pipe.

13. The system of claim 11, wherein:
the heat exchanger comprises a first aluminum alloy;
the outer structure comprises a second aluminum alloy;
the heat exchanger is connected to the heat pipe with a cladding material associated with a melt temperature lower than:
a melt temperature of the first aluminum alloy; and
a melt temperature of the second aluminum alloy.

14. The system of claim 9, wherein the heat pipe comprises a flat-thin heat pipe.

15. The system of claim 14, wherein the heat pipe comprises a wicking comprising copper configured to apply capillary pressure to the coolant, moving the coolant from a condensation portion of the heat pipe to an evaporation portion of the heat pipe.

16. The system of claim 9, wherein the barrier layer comprises 2 atoms or more, and wherein the barrier layer comprises uniform thickness within 1 atom.

17. The system of claim 9, wherein the barrier layer is generated using one of:
diffusion bonding of copper atoms on an inside wall of the outer structure;
electro-deposition of copper atoms on the inside wall;
vapor bonding of copper atoms to the inside wall; and
in-air copper atom plasma deposition.

18. The system of claim 9, comprising an additional barrier layer comprising an intermetallic compound, wherein the additional barrier layer is disposed between the barrier layer and the aluminum outer structure.

19. A method for manufacturing a cooling system, the method comprising:
generating a bi-metal comprising:
aluminum; and
a lining comprising copper;
configuring a heat pipe from the bi-metal such that the lining is disposed within the heat pipe;
evacuating air from within the heat pipe until a pressure inside the heat pipe reaches a specified threshold;
adding coolant inside of the heat pipe; and
sealing the heat pipe.

20. The method of claim 19, wherein configuring the heat pipe comprises positioning a wicking comprising copper within the heat pipe, wherein the wicking is configured to exert capillary pressure to the coolant, moving the coolant from a condensation portion of the heat pipe to an evaporation portion of the heat pipe.

21. The method of claim 19, comprising skiving fins out of an outer structure of the heat pipe, wherein the fins are configured to perform a heat exchanger function for the heat pipe.

22. The method of claim 19, comprising:
positioning a cladding material between a heat exchanger and the heat pipe, wherein the heat exchanger comprises a first aluminum alloy, and wherein the heat pipe comprises an outer structure comprising a second aluminum alloy, and wherein the cladding material is associated with a melt temperature lower than:
a melt temperature of the first aluminum alloy; and
a melt temperature of the second aluminum alloy;
bonding the heat exchanger to the heat pipe by heating the heat exchanger, heat pipe, and cladding material to a temperature: above a melt temperature of the cladding material; below a melt temperature of the first aluminum alloy; and below a melt temperature of the second aluminum alloy.
